(19) United States
(12) Patent Application Publication
(10) Pub. No.: US 2008/0080602 A1
(43) Pub. Date: Apr. 3, 2008

(54) TRANSMITTING DATA BETWEEN A DATA PROCESSING DEVICE AND A MODEM

(75) Inventor: Dan DINESCU, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/865,197

(22) Filed: Oct. 1, 2007

(30) Foreign Application Priority Data
Sep. 29, 2006 (DE) 10 2006 046 187.8

(51) Int. Cl. H04B 1/38

(52) U.S. Cl. 375/222

(57) ABSTRACT

A data transmission between a data processing device, which is coupled to a network by means of a modem, and the modem. Data, which have been transmitted by the modem, are received in data packets of a first type in a format in accordance with a first data transmission protocol. The received data are extracted from the data packets of the first type, and the extracted received data are provided in data packets of a second type in a format in accordance with a second data transmission protocol to the data processing device.

### CROSS-REFERENCE TO RELATED APPLICATION

This application claims priority to German Patent Application Serial No. 10 2006 046 187.8, which was filed Sep. 29, 2006, and is incorporated herein by reference in its entirety.

### TECHNICAL FIELD

Embodiments of the invention relate generally to methods for transmitting data, to a data processing device for transmitting data, and to computer program products for transmitting data.

### BACKGROUND

It is desirable to carry out the communication between a data processing device, which is coupled to a network by means of a modem, and the modem in a way that is respectively suitable for both of the communication partners. By way of example, it is desirable to carry out the communication in such a way that is suitable for the processing, by means of the modem, of the high data rates which are possible in modem networks, and, at the same time, in such a way that is compatible with existing techniques at the side of the data processing device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a data processing device in accordance with an embodiment of the invention, coupled to a network by means of a modem; and

FIG. 2 shows a flow diagram of the data transmission in accordance with an embodiment of the invention.

### DESCRIPTION

Known techniques for the communication between a data processing device, which is coupled to a network by means of a modem, and the modem, are based on the circumstances and conditions that exist or are already foreseeable at the time instant of its generation and development. The data amount to be transmitted and thus, the required data rates have increased rapidly in the recent time and will increase in the future. In particular, the introduction and further development of the UMTS mobile radio generation will result in a large increase of the available data rates for data transmission by means of the mobile radio networks.

The connecting possibility for a so-called “legacy modem”, which corresponds approximately to the German term “old system modem”, known from a PC operating system, is a historically grown part of the operating system, which is included also in newer versions of the operating system for compatibility reasons. A modem may be, as a “legacy modem” for example at a personal computer (PC), coupled to such an operating system via a COM terminal, i.e. via a serial interface, and may be controlled by the PC using AT instructions. In order to use a modem as a “legacy modem”, it is sufficient to install a file including information describing the modem, wherein the name of the file has the ending “.inf”, and to configure a dial-in network. The Point-to-Point protocol (PPP) is used for the data transfer from the PC to the modem and vice versa, e.g. in a connection with an internet service provider via the modem. On the one side, e.g. in the modem, the data are packetized into data packets in accordance with the PPP, and on the other side, e.g. in the PC, the data are depacketized from the data packets.

In case that a modem is connected to the PC via an interface in accordance with the Universal Serial Bus (USB), the USB driver software in the PC can simulate a COM terminal to the operating system of the PC, and the modem can be operated as “legacy modem” using the PPP.

A mobile radio telephone can be connected to the PC as a modem for coupling a PC with a mobile radio network, e.g. via a serial interface or via a USB interface. If the mobile radio telephone is connected as a “legacy modem”, the PPP may also be used in the mobile radio telephone for data transmission from and to the PC.

Since PPP is a byte-oriented data transmission protocol, the processor load caused by the PPP scales with the bandwidth of the data transmission. In particular in modern or future UMTS mobile radio networks, this may be of importance. In High Speed Downlink Packet Access (HSDPA), i.e. in a packet-switched high speed connection for downloading data from the UMTS mobile radio network, the bandwidth of the data transmission may be in the range of several Megabit per second. Activities taking place in the 3GPP standardization groups under the name “Long Term Evolution” (LTE) have the object of further developing UMTS for the packet data transmission with data rates up to 100 Megabit per second.

Embodiments which are described in the following in the context with the methods for transmitting data correspondingly apply to a data processing device for transmitting data and to a computer program product for transmitting data.

In accordance with various embodiments of the invention, illustratively, the data transmitted by the modem or the data transmitted to the modem in the context of the data transmission between the modem and the data processing device are formatted in accordance with a first data transmission protocol, which is suitable for the processing of the high data rates which are possible in modem networks by means of the modem. Also illustratively, the data provided by or the data provided to the data processing device for further processing are formatted in accordance with a second date transmission protocol, which is compatible with the existing techniques for data transmission on the side of the data processing device. Illustratively, a data format conversion takes place in the data transmission, in which the data packets of the one type are depacketized and the thus obtained raw data are packetized into data packets of the other type so that the data can be provided or processed by the modem or the data processing device directly in the respectively suitable format.

In an embodiment of the invention, the data provided by the data processing device are provided using an information which describes characteristics of the modem.

In accordance with an embodiment of the invention, embodiments of the invention, which refer to the transmission of data from the modem to the data processing device, can be combined with embodiments of the invention, which refer to the transmission of data from the data processing device to the modem.

In accordance with various embodiments of the invention, the first data transmission protocol may have a higher ratio of useful data rate and total data rate than the second data transmission protocol.

In accordance with various embodiments of the invention, the first data transmission protocol is a packet-oriented data transmission protocol.

In accordance with various embodiments of the invention, the second data transmission protocol may be a byte-oriented data transmission protocol.

In accordance with various embodiments of the invention, the second data transmission protocol may be the Point-to-Point protocol.

In accordance with various embodiments of the invention, the data in data packets of the first type in the format in accordance with the first data transmission protocol is transmitted and/or received by means of a USB interface. The data to be extracted can be extracted from data packets of the first type received via a USB interface and/or the data packets of the first type may be provided for the transmission via a USB interface.

In accordance with various embodiments of the invention, the modem is an HSDPA capable UMTS mobile radio modem.

In accordance with various embodiments of the invention, the data processing device may be a personal computer.

In accordance with various embodiments of the invention, a data processing device is configured to carry out a method in accordance with one embodiment of the invention or in accordance with a plurality of embodiments of the invention.

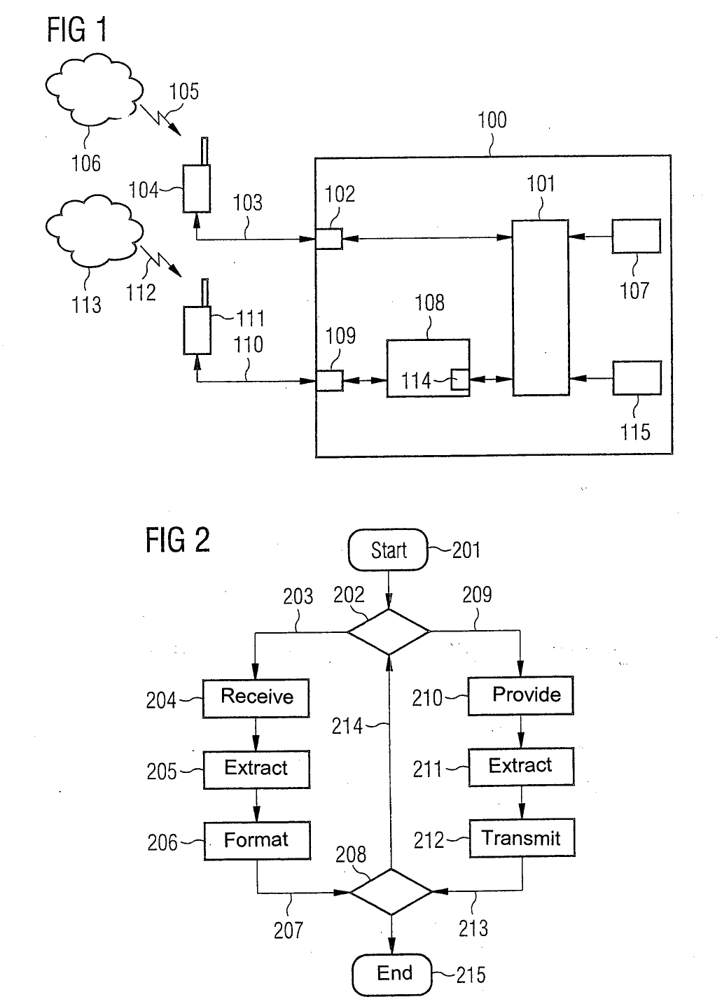

Referring now to FIG. 1, a data processing device in accordance with an embodiment of the invention, coupled to a network via a modem, will be described in more detail below. In FIG. 1, blocks symbolize device units or processes, wherein the processes may be implemented in hardware and/or in software. The hardware may include hard-wired logic or programmable logic (e.g. a microprocessor, e.g. a Complex Instruction Set Computer (CISC) processor or a Reduced Instruction Set Computer (RISC) processor) realizing the respective functionality.

A data processing device 100, in particular a PC, includes, inter alia, an operating system 101, which is executed by a processor of the PC, and an interface 102. A mobile radio telephone 104 is connected to the interface 102 via a data line 103. In an embodiment of the invention, the interface 102 is a COM interface of the PC. The data connection between the mobile radio telephone 104 and the PC or the interface 102 may also be implemented as a radio link, e.g. in Bluetooth technique. The mobile radio telephone 104 is coupled with a mobile radio network 106 via an air interface or radio link 105. The mobile radio telephone 104 can be used as a “legacy modem” under the operating system 101 by means of describing information from a file 107, e.g. a driver software. The operating system 101 transmits data, which are formatted in accordance with the Point-to-Point Protocol (PPP), via the COM interface 102 to the modem, i.e. the mobile radio telephone 104, and receives data formatted in accordance with the PPP from the modem via the reverse path.

The operating system 101 is further connected with a USB driver 108. The term “driver” may herein be understood as a driver software as well as a processor, by which the driver software is executed. This processor can be the same processor as the processor which executes the operating system 101, or this processor can be another processor than the processor which executes the operating system 101. The USB driver 108 is coupled with a USB interface 109 of the PC. A mobile radio telephone 111 is coupled to the USB interface 109 of the PC via a data line 110, which may also be implemented as a radio link. The mobile radio telephone 111 is coupled with a mobile radio network 113 via an air interface or a radio link 112. The USB driver 108 provides a simulated COM interface 114 to the operating system. The mobile radio telephone 111 can be used as a “legacy modem” under the operating system via the simulated COM interface 114 and by means of describing information from the file 115. Data to be transmitted between the operating system 101 and the USB driver 108 are formatted in accordance with PPP.

A data transmission protocol is used for the data transmission between the USB driver 108 and the mobile radio telephone 111 which is well suitable for these two communication partners. In particular in case that the mobile radio network 113 is a UMTS network and the mobile radio telephone 111 is HSDPA capable, very high data rates in the range of several Megabit per second may occur in the data transmission between the network and the PC, in particular in the upload and/or download of data between the network and the PC. In case that the PPP is used for this, an adverse high work load of the processor in the mobile radio telephone 111 may be the result of this. In order to reduce the processor load in the mobile radio telephone 111, the data are transmitted to the USB driver 108 by means of a protocol which is better suitable than the PPP. This can e.g. be an Ethernet protocol or a similar packet-oriented protocol. In the Ethernet protocol, a more efficient packing of the data is taking place compared with the PPP, which reduces the load of the processor used for the packetizing. The data which are e.g. downloaded from the network are depacketized from the packets of the Ethernet protocol in the USB driver 108. The data are packetized in packets in accordance with the PPP, which are forwarded to the operating system 101. Data, which the USB driver 108 has received from the operating system 101, are depacketized. The thus obtained raw data are packetized into packets in accordance with the Ethernet protocol, and the packets are transmitted to the mobile radio telephone 111. The USB driver 108 supports the mobile radio telephone 111 as external Ethernet function of the PC. The USB driver 108 appears vis-a-vis the operating system 101 as one or more COM terminals. In other words: a COM interface 114 is simulated by means of the USB driver 108. The USB driver 108 can be considered as a data converting unit, whereby a data transmission is enabled by means of the PPP used by the operating system 101 and by means of the Ethernet protocol used by the mobile radio telephone 111. By using a more efficient protocol in the mobile radio telephone 111, the load of its processor is reduced. The data conversion by means of the USB driver 108 does not represent a significant additional load for a conventional processor of a PC.

In an embodiment of the invention, a data connection via a USB interface is described, because a USB data connection allows a data transmission with similar high data rates as they e.g. occur at the data transmission by means of HSDPA. Alternatively, other interfaces may be used which allow data transmissions with high data rates and the data conversion may also occur independent from an interface driver. In order to reduce the processor load in the modem, any data transmission protocol can be used which has a higher ratio of useful data rate and total data rate than the PPP. A packet-oriented protocol such as e.g. the Ethernet protocol is in this sense more efficient than the byte-oriented PPP. In the context of the embodiments of the invention, any protocol may be used at the side of the modem which is more suitable for the processing of the data in the modem and in particular for high data rates than the PPP, whereas the operating system 101 of the PC continues to use the PPP.

Referring to FIG. 2, a flow diagram of the data transmission in accordance with an embodiment of the invention will be described in more detail below. In the flow diagram shown in FIG. 2, a rectangle symbolizes a state or a process, a rounded rectangle symbolizes a starting point or an end point of the flow, and a rhombus symbolizes a node as a decision point with a plurality of possible paths for the continuation of the flow. Paths are symbolized by means of arrows.

The flow begins with the starting point “Start” 201. In node 202, it is decided as to whether, from the point of view of the data processing device, data should be received or transmitted.

In case that in node 202 it has been decided that from the point of view of the data processing device that data should be received, the flow will proceed with the process “Receive” 204 via the path 203. Data which have been transmitted by the modem are received in data packets with a format in accordance with the data transmission protocol used by the modem. Then, the flow proceeds with the process “Extract” 205. The obtained data packets are depacketized and thus, the received data are extracted as raw data. The flow proceeds with the process “Format” 206. The extracted received data are packetized into data packets with a format in accordance with the data transmission protocol, with which they should be provided to the data processing device, and then, the data are provided to the data processing device.

The flow proceeds with the node 208 via the path 207, wherein in node 208 it is decided as to whether the data transmission should be continued or terminated.

In case that in node 202 it has been decided that from the point of view of the data processing device it should be transmitted, the flow proceeds with the process “Provide” 210 via the path 209. The data to be transmitted are provided in data packets with a format in accordance with the protocol used by the data processing device for data to be provided. The flow proceeds with the process “Extract” 211. The provided data packets are depacketized and the thus provided data are obtained as raw data. Then, the flow proceeds with the process “Transmit” 212. The obtained raw data are packetized into data packets with a format in accordance with the data transmission protocol used by the modem, and the data packets are transmitted to the modem. The flow then proceeds with the deciding node 208 via the path 213, in which it is decided as to whether the data transmission should be continued or terminated.

In case that in node 208 it has been decided that the data transmission should be continued, the flow proceeds with the node 202 via the path 214. Otherwise, the flow is terminated with the end point “End” 215.

In an embodiment of the invention, a method for transmitting data between a data processing device, which is coupled to a network by means of a modem, and the modem is provided, wherein data are transmitted from the modem to the data processing device. The method may include receiving data which have been transmitted by the modem in data packets of a first type in a format in accordance with a first data transmission protocol, extracting the received data from the data packets of the first type, and providing the extracted received data in data packets of a second type in a format in accordance with a second data transmission protocol to the data processing device.

In another embodiment of the invention, a method for transmitting data between a data processing device, which is coupled to a network by means of a modem, and the modem is provided, wherein data are transmitted from the data processing device to the modem. The method may include the data processing device providing data in data packets of a second type in a format in accordance with a second data transmission protocol, extracting the received data from the data packets of the second type, and transmitting the extracted provided data in data packets of a first type in a format in accordance with a first data transmission protocol to the modem.

In an embodiment of the invention, a data processing device is provided. In an embodiment of the invention, the data processing device is configured to carry out a method for transmitting data between a data processing device, which is coupled to a network by means of a modem, and the modem, wherein data are transmitted from the modem to the data processing device. The method may include receiving data which have been transmitted by the modem in data packets of a first type in a format in accordance with a first data transmission protocol, extracting the received data from the data packets of the first type, and providing the extracted received data in data packets of a second type in a format in accordance with a second data transmission protocol to the data processing device. Furthermore, in an embodiment of the invention, data processing device is configured to carry out a method for transmitting data between a data processing device, which is coupled to a network by means of a modem, and the modem, wherein data are transmitted from the data processing device to the modem. The method may include the data processing device providing data in data packets of a second type in a format in accordance with a second data transmission protocol, extracting the received data from the data packets of the second type, and transmitting the extracted provided data in data packets of a first type in a format in accordance with a first data transmission protocol to the modem.

In an embodiment of the invention, a computer program product for transmitting data between a data processing device, which is coupled to a network by means of a modem, and the modem is provided, wherein, when the computer program product is executed by a processor, data are transmitted from the modem to the data processing device. The in this case executed method may include extracting data, which the modem has transmitted in data packets of a first type in a format in accordance with a first data transmission protocol and which have been received in data packets of the first type, from the received data packets of the first type, and providing the extracted received data in data packets of a second type in a format in accordance with a second data transmission protocol to the data processing device.

In another embodiment of the invention, a computer program product for transmitting data between a data processing device, which is coupled to a network by means of a modem, and the modem is provided, wherein, when the computer program product is executed by a processor, data are transmitted from the data processing device to the modem. The in this case executed method may include extracting data, which have been provided by the data processing device in data packets of a second type in a format in accordance with a second data transmission protocol, from the data packets of the second type, and providing the extracted provided data in data packets of a first type in a format in accordance with a first data transmission protocol for the transmission to the modem.

In an embodiment of the invention, the first data transmission protocol has a higher ratio of useful data rate and total data rate than the second data transmission protocol.

The first data transmission protocol may be a packet-oriented data transmission protocol.

The second data transmission protocol may be a byte-oriented data transmission protocol.

The second data transmission protocol may be the Point-to-Point protocol.

In an embodiment of the invention, when the computer program product is executed out by a processor, a method is carried out, the method including: in case that data are transmitted from the modem to the data processing device, the data to be extracted are extracted from data packets of the first type received by means of a USB interface, and in case that data are transmitted from the data processing device to the modem, the data packets of the first type are provided for the transmission by means of the USB interface.

The modem may be an HSDPA capable UMTS mobile radio modem.

Furthermore, the data processing device may be a personal computer.

While the invention has been particularly shown and described with reference to specific embodiments, is should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for transmitting data between a data processing device, which is coupled to a network by means of a modem, and the modem, wherein data are transmitted from the modem to the data processing device, and the method comprising:
receiving data which have been transmitted by the modem in data packets of a first type in a format in accordance with a first data transmission protocol;
extracting the received data from the data packets of the first type; and
providing the extracted received data in data packets of a second type in a format in accordance with a second data transmission protocol to the data processing device.

2. The method of claim 1,
wherein the first data transmission protocol has a higher ratio of useful data rate and total data rate than the second data transmission protocol.

3. The method of claim 1,
wherein the first data transmission protocol is a packet-oriented data transmission protocol.

4. The method of claim 1,
wherein the second data transmission protocol is a byte-oriented data transmission protocol.

5. The method of claim 1,
wherein the second data transmission protocol is the Point-to-Point protocol.

6. The method of claim 1,
wherein the data in data packets of the first type in the format in accordance with the first data transmission protocol are transmitted or received by means of a USB interface.

7. The method of claim 1,
wherein the modem is an HSDPA capable UMTS mobile radio modem.

8. The method of claim 1,
wherein the data processing device is a personal computer.

9. A method for transmitting data between a data processing device, which is coupled to a network by means of a modem, and the modem, wherein data are transmitted from the data processing device to the modem, and the method comprising:
the data processing device providing data in data packets of a second type in a format in accordance with a second data transmission protocol;
extracting the received data from the data packets of the second type; and
transmitting the extracted provided data in data packets of a first type in a format in accordance with a first data transmission protocol to the modem.

10. The method of claim 9,
wherein the data provided by the data processing device are provided using an information describing characteristics of the modem.

11. The method of claim 9,
wherein the first data transmission protocol has a higher ratio of useful data rate and total data rate than the second data transmission protocol.

12. The method of claim 9,
wherein the first data transmission protocol is a packet-oriented data transmission protocol.

13. The method of claim 9,
wherein the second data transmission protocol is a byte-oriented data transmission protocol.

14. The method of claim 9,
wherein the second data transmission protocol is the Point-to-Point protocol.

15. The method of claim 9,
wherein the data in data packets of the first type in the format in accordance with the first data transmission protocol are transmitted or received by means of a USB interface.

16. The method of claim 9
wherein the modem is an HSDPA capable UMTS mobile radio modem.

17. The method of claim 9,
wherein the data processing device is a personal computer.

18. A data processing device,
configured to carry out a method for transmitting data between a data processing device, which is coupled to a network by means of a modem, and the modem, wherein data are transmitted from the modem to the data processing device, the method comprising:
receiving data which have been transmitted by the modem in data packets of a first type in a format in accordance with a first data transmission protocol;
extracting the received data from the data packets of the first type; and
providing the extracted received data in data packets of a second type in a format in accordance with a second data transmission protocol to the data processing device; or
configured to carry out a method for transmitting data between a data processing device, which is coupled to a network by means of a modem, and the modem, wherein data are transmitted from the data processing device to the modem, and the method comprising:
the data processing device providing data in data packets of a second type in a format in accordance with a second data transmission protocol;
extracting the received data from the data packets of the second type; and
transmitting the extracted provided data in data packets of a first type in a format in accordance with a first data transmission protocol to the modem.

19. A computer program product for transmitting data between a data processing device, which is coupled to a network by means of a modem, and the modem, wherein, when the computer program product is executed by a processor, data are transmitted from the modem to the data processing device, and a method would be executed, the method comprising:
extracting data, which the modem has transmitted in data packets of a first type in a format in accordance with a first data transmission protocol and which have been received in data packets of the first type, from the received data packets of the first type; and
providing the extracted received data in data packets of a second type in a format in accordance with a second data transmission protocol to the data processing device.

20. The computer program product of claim 19,
wherein the first data transmission protocol has a higher ratio of useful data rate and total data rate than the second data transmission protocol.

21. The computer program product of claim 19,
wherein the first data transmission protocol is a packet-oriented data transmission protocol.

22. A computer program product for transmitting data between a data processing device, which is coupled to a network by means of a modem, and the modem, wherein, when the computer program product is executed by a processor, data are transmitted from the data processing device to the modem, and a method would be executed, the method comprising:
extracting data, which have been provided by the data processing device in data packets of a second type in a format in accordance with a second data transmission protocol, from the data packets of the second type; and
providing the extracted provided data in data packets of a first type in a format in accordance with a first data transmission protocol for the transmission to the modem.

23. The computer program product of claim 22,
wherein the first data transmission protocol has a higher ratio of useful data rate and total data rate than the second data transmission protocol.

24. The computer program product of claim 22,
wherein the first data transmission protocol is a packet-oriented data transmission protocol.

25. The computer program product of claim 22,
wherein the data provided by the data processing device are provided using an information describing characteristics of the modem.
